(19) United States
(12) Patent Application Publication
(10) Pub. No.: US 2004/0141496 A1
(43) Pub. Date: Jul. 22, 2004

(54) Optimization of transmissions on a shared communications channel

(76) Inventor: Maarten Menzo Wentink, Utrecht (NL)

Correspondence Address: DEMONT & BREYER, LLC, SUITE 250, 100 COMMONS WAY, HOLMDEL, NJ, 07733, US

(21) Appl. No.: 10/421,274

(22) Filed: Apr. 23, 2003

Related U.S. Application Data
(60) Provisional application No. 60/440,576, filed on Jan. 16, 2003.

(51) Int. Cl. H04L 12/66

(52) U.S. Cl. 370/354

(57) ABSTRACT

A technique for optimizing transmissions on a shared communications channel is disclosed. When legacy stations and enhanced stations are present on the same shared communications channel, control frames can be used to make the communications between enhanced stations visible to the legacy stations. The technique disclosed selects between multiple control frames when more than one candidate control frame is available.

### Cross-Reference to Related Applications

This application claims the benefit of U.S. Provisional Patent Application Serial No. 60/440,576, entitled “OFDM Protection Optimization in Clients,” filed on Jan. 16, 2003 (Attorney Docket: 680-042us), which is incorporated by reference.

### FIELD OF THE INVENTION

The present invention relates to telecommunications in general, and, more particularly, to wireless local area networks.

### BACKGROUND OF THE INVENTION

FIG. 1 depicts a schematic diagram of a portion of wireless local area network 100 in the prior art. Local area network 100 comprises communications stations 101, 102-1, and 102-2. Station 101 is a legacy station, and stations 102-1 and 102-2 are enhanced stations. Station 101, as a legacy station, is capable of transmitting and receiving on a shared communications channel in accordance with a first modulation scheme only, such as complementary code keying (CCK). In contrast, stations 102-1 and 102-2 are capable, as enhanced stations, of transmitting and receiving on the shared communications channel in accordance with either a first modulation scheme or a second modulation scheme. An example of the second modulation scheme is orthogonal frequency division multiplexing (OFDM). Consequently, station 101 and station 102-2 must communicate with each other using the first modulation scheme. Stations 102-1 and 102-2, however, are able to communicate with each other using either the first or second modulation scheme.

Stations 102-1 and 102-2 communicate with each other using the second modulation scheme whenever possible, since doing so can optimize (e.g., speed up, etc.) communications. One effect of using the second modulation scheme, however, is that station 101 cannot detect the communications between station 102-1 and 102-2 (i.e., stations 102-1 and 102-2 are essentially invisible to station 101 when stations 102-1 and 102-2 are communicating using the second modulation scheme).

### SUMMARY OF THE INVENTION

One technique that makes an enhanced station visible to a legacy station involves having the enhanced station transmit a control frame using a legacy modulation scheme before transmitting a data frame using an enhanced modulation scheme. In some protocols, a station can select between multiple control frames, such as request_to_send and clear_to_send frames. Having this flexibility might seem desirable, but in fact, selecting the “wrong” control frame can result in a loss of transmission efficiency on the shared communications channel.

To illustrate the drawback, suppose that an enhanced station selects a clear_to_send frame as the control frame to be transmitted via the legacy modulation scheme. In this case, if a collision occurs, the station will not be aware that a collision has occurred until after the station has also transmitted the subsequent data frame and has experienced a timeout. Furthermore, the longer the data frame, the costlier the collision, in terms of lost bandwidth and time. In contrast, if the enhanced station selects a request_to_send frame as the control frame to be transmitted via the enhanced modulation scheme and if a collision occurs, the station becomes aware that a collision has occurred as soon as it times out, having not received a corresponding clear_to_send. Therefore, it appears that a request_to_send frame is better to use than a clear_to_send frame. There is, however, a cost in always using a request_to_send as the control frame, since the corresponding clear_to_send frame must always be received before the data frame can be sent, consuming bandwidth.

The present invention addresses this frame selection dilemma by selecting a control frame to transmit before a data frame, wherein the selection of the control frame at a transmitting station is based on the length of time required to transmit the data frame. If the length of time is large, then the transmitting station selects a first frame as the control frame. If the length of time is small, then the transmitting station selects a second frame as the control frame.

Some embodiments of the present invention account for the collision threshold applicable to the shared communications channel in use. The collision threshold represents the relative amount of collisions occurring or expected to occur.

The illustrative embodiment of the present invention comprises: selecting a control frame from a first frame and a second frame to transmit before a data frame wherein the selection of the control frame is based on the length of time required to transmit the data frame; transmitting the control frame on a shared-communications channel in accordance with a first modulation scheme; and transmitting the data frame on the shared-communications channel in accordance with a second modulation scheme that is different than the first modulation scheme.

### BRIEF DESCRIPTION OF THE DRAWINGS

FIG. 1 depicts a schematic diagram of a portion of wireless local area network 100 in the prior art.

FIG. 2 depicts host computer 201 and station 202 in accordance with the illustrative embodiment of the present invention.

FIG. 3 depicts a block diagram of the salient components of station 202 in accordance with the illustrative embodiment of the present invention.

FIG. 4 depicts a flowchart of the illustrative embodiment of the present invention.

FIG. 5 depicts a schematic diagram of a request_to_send control frame in accordance with the illustrative embodiment of the present invention.

FIG. 6 depicts a schematic diagram of a clear_to_send control frame in accordance with the illustrative embodiment of the present invention.

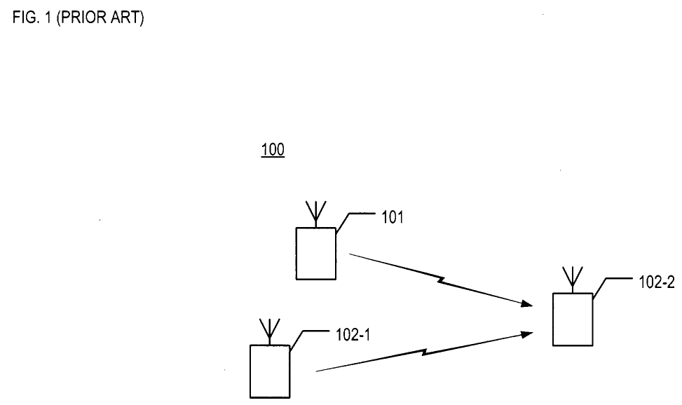

### DETAILED DESCRIPTION

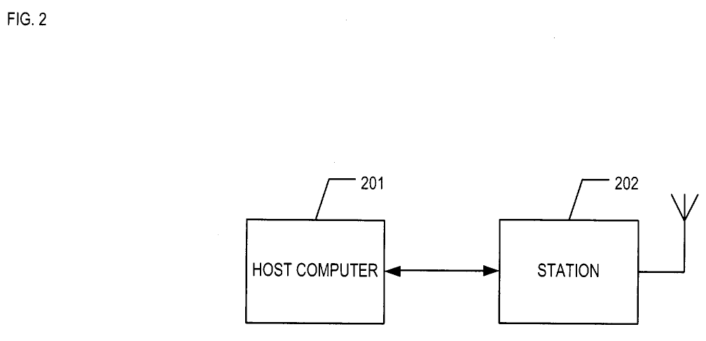

FIG. 2 depicts a block diagram of the salient components of host computer 201 and station 202 in accordance with the illustrative embodiment of the present invention. Host computer 201 is capable of generating data messages and transmitting those data messages to station 202. Host computer 201 is also capable of receiving data messages from station 202 and of processing and using the data contained within those data messages. It will be clear to those skilled in the art how to make and use host computer 201.

Station 202 is capable of receiving data messages from host computer 201 and transmitting over a shared communications channel data frames comprising the data received from host computer 201. Station 202 is also capable of receiving data frames from the shared communications channel and sending to host computer 201 data messages comprising data from the data frames. It will be clear to those skilled in the art, after reading this specification, how to make and use station 202.

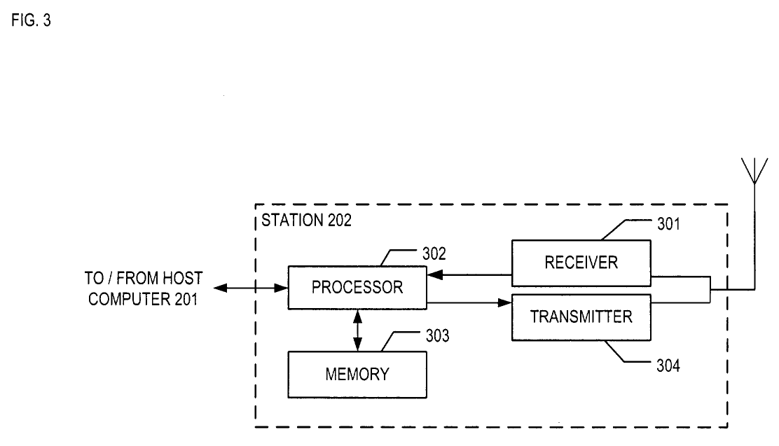

FIG. 3 depicts a block diagram of the salient components of station 202 in accordance with the illustrative embodiment of the present invention. Station 202 comprises receiver 301, processor 302, memory 303, and transmitter 304, interconnected as shown.

Receiver 301 is a circuit that is capable of receiving frames from the shared communications channel, in well-known fashion, and of forwarding them to processor 302. The frames include both data frames and control frames. Examples of control frames include request_to_send, clear_to_send, and acknowledgement frames. It will be clear to those skilled in the art how to make and use receiver 301.

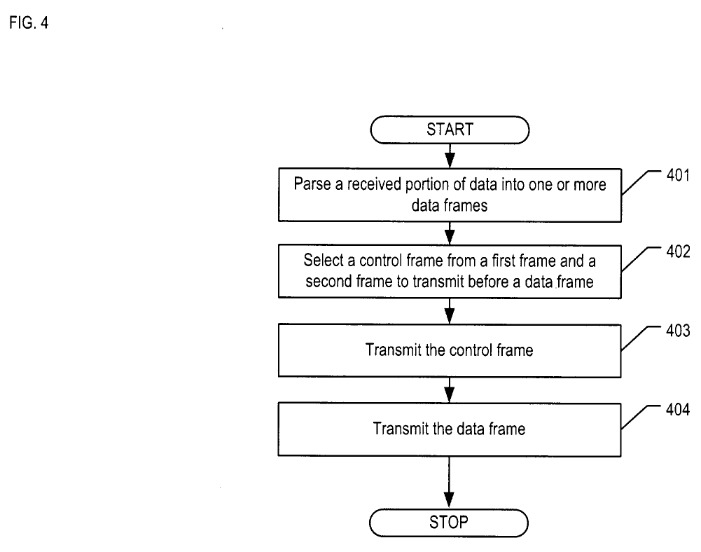

Processor 302 is a general-purpose processor that is capable of performing the tasks described below and with respect to FIGS. 4, 5, and 6. It will be clear to those skilled in the art, after reading this specification, how to make and use processor 302.

Memory 303 is capable of storing programs and data used by processor 302. It will be clear to those skilled in the art how to make and use memory 303.

Transmitter 304 is a circuit that is capable of receiving frames from processor 302, in well-known fashion, and of transmitting them on the shared communications channel. It will be clear to those skilled in the art, after reading this specification, how to make and use transmitter 304.

FIG. 4 depicts a flowchart of the salient tasks performed by the illustrative embodiment of the present invention. It will be clear to those skilled in the art which tasks depicted in FIG. 4 can be performed simultaneously or in a different order than that depicted.

At task 401, processor 302 receives data from host computer 201, parses the data into one or more frames, in well-known fashion, and stores the frames into memory 303.

Before transmitting the data received from host computer 201, processor 302 at task 402 selects a control frame from a first frame and second frame. The first frame and second frame, essentially “candidate” frames, are described in detail below. Processor 302 makes the selection based on the length of time required to transmit the first data frame from the portion of data to be transmitted. Processor 302 selects the control frame for the purpose of transmitting the control frame before transmitting one or more data frames.

In accordance with the illustrative embodiment of the present invention, the length of time required to transmit a data frame is compared against a mathematical expression. The expression comprises the length of time required to transmit the first candidate frame, D₁; the length of time required to transmit the second candidate frame, D₂; and the collision fraction, F, of the shared communications channel. It will be clear to those skilled in the art how to determine the length of time required to transmit the first candidate frame and the length of time required to transmit the second candidate frame.

The collision fraction represents the fraction of transmissions on the shared communications channel that result in collisions. The collision fraction can be determined by estimation, by basing it on measurements of previous sent frames, or through some other method. The collision fraction can be a static property, or it can be updated over time. It will be clear to those skilled in the art how to determine and use the collision fraction.

The average duration, D_{A}, of a first IEEE 802.11 message sequence comprising a clear_to_send frame, followed by a data frame, followed by an acknowledgement frame is equal to:

D_{A}=(1−F)*(D_{CTS}+D_{Data}+D_{Ack})+F*(D_{CTS}+D_{Data}) (Eq. 1)

wherein F is the collision threshold, and D_{CTs}, D_{Data}, and D_{Ack} refer to the lengths of time required to transmit the clear_to_send, data, and acknowledgement frames, respectively, accounting for the intermediate time intervals contributed by interframe spaces (e.g., short interframe space, etc.). Similarly, the average duration, D_{B}, of a second IEEE 802.11 message sequence comprising a request_to_send frame, followed by a clear_to_send frame, followed by a data frame, followed by an acknowledgement frame is equal to:

D_{B}=(1−F)*(D_{RTS}+D_{CTs}+D_{Data}+D_{Ack})+F*(D_{RTS}) (Eq. 2)

wherein F is the collision threshold, and D_{RTS}, D_{CTS}, D_{Data}, and D_{ACk} refer to the lengths of time required to transmit the request_to_send, clear_to_send, data, and acknowledgement frames, respectively, accounting for the intermediate time intervals contributed by interframe spaces.

By setting D_{A} and D_{B} equal to each other and solving for D_{Data}, the value for D_{Data} at which the use of either message sequence results in equal levels of optimization is determined to be equal to:

(D₁−D₂*F)/F (Eq. 3)

wherein D₁ and D₂ are generalizations of D_{RTS} and D_{CTS}, respectively.

At task 403, transmitter 304 transmits the control frame on the shared communications channel. Transmitter 304 transmits the control frame in accordance with a first modulation scheme. An example of a first modulation scheme is complementary code keying, which is known in the art.

At task 404, transmitter 304 transmits the data frame on the shared communications channel. Transmitter 304 transmits the data frame in accordance with a second modulation scheme. An example of a second modulation scheme is orthogonal frequency division multiplexing, which is known in the art. The modulation scheme used to transmit the data frame can be the same as the modulation scheme used to transmit the control frame, or it can be different.

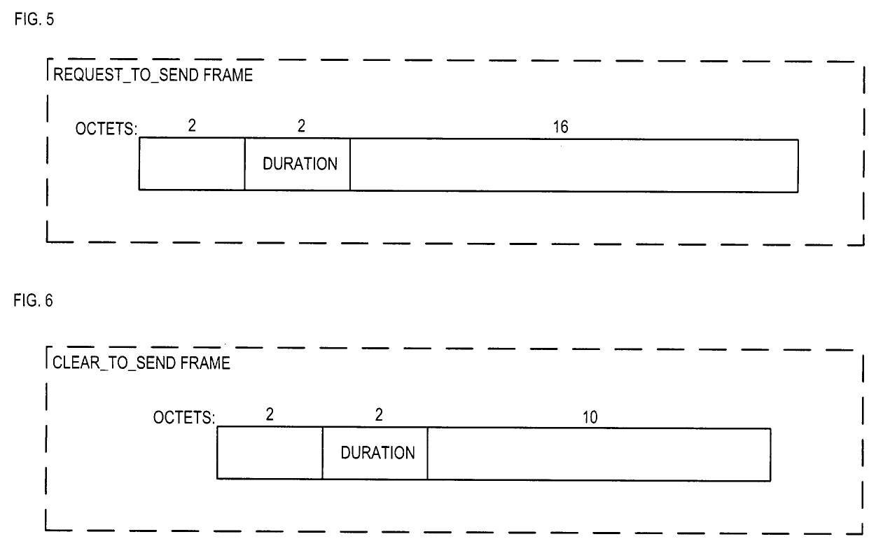

FIG. 5 depicts a block diagram of a first type of control frame in accordance with the illustrative embodiment of the present invention. The request_to_send frame depicted is the first of two possible frames selected as the control frame and transmitted by station 202. The request_to_send frame, when received by any station, has the effect of invoking the virtual carrier-sense mechanism of that station, as is known in the art.

The virtual carrier-sense mechanism in IEEE 802.11 relies on a two-octet duration field, depicted in FIG. 5 along with other fields. The duration field contains a value that is used by the receiving station to update, in well-known fashion, the network allocation vector (NAV) that is part of the virtual carrier-sensing mechanism. The value in the duration field is based on the length of time required to transmit the one or more frames associated with the request_to_send frame. Typically, the value in the duration field is also based on an estimate of the length of time covering:

transmission of the corresponding clear_to_send frame sent back to station 202;

transmission of the subsequent data frames;

transmission of the acknowledgement frames that correspond to the data frames; and

any required spacing between the individual frames.

It will be clear to those skilled in the art how to create and use a request_to_send frame.

FIG. 6 depicts a block diagram of a second type of control frame in accordance with the illustrative embodiment of the present invention. The clear_to_send frame depicted is the second of two possible frames selected as the control frame to be transmitted by station 202. The clear_to_send frame, when received by any station, has the effect of invoking the virtual carrier-sense mechanism of that station, as is known in the art.

The virtual carrier-sense mechanism in IEEE 802.11 relies on a two-octet duration field, depicted in FIG. 6 along with other fields. The duration field contains a value that is used by the receiving station to update, in well-known fashion, the network allocation vector (NAV) that is part of the virtual carrier-sensing mechanism. The value in the duration field is based on the length of time required to transmit the one or more frames associated with the clear_to_send frame. Typically, the value in the duration field is also based on an estimate of the length of time covering:

transmission of the subsequent data frames;

transmission of the acknowledgement frames that correspond to the data frames; and

any required spacing between the individual frames.

It will be clear to those skilled in the art how to create and use a clear_to_send frame.

It is to be understood that the above-described embodiments are merely illustrative of the present invention and that many variations of the above-described embodiments can be devised by those skilled in the art without departing from the scope of the invention. It is therefore intended that such variations be included within the scope of the following claims and their equivalents.

What is claimed is:

1. A method comprising:
selecting a control frame from a first frame and a second frame to transmit before a data frame wherein the selection of said control frame is based on the length of time required to transmit said data frame;
transmitting said control frame on a shared-communications channel in accordance with a first modulation scheme; and
transmitting said data frame on said shared-communications channel in accordance with a second modulation scheme that is different than said first modulation scheme.

2. The method of claim 1 wherein said first frame is a Request_to_Send frame and said second frame is a Clear_to_Send frame.

3. The method of claim 1 wherein said control frame comprises a duration field that has a value based on the length of time required to transmit said data frame.

4. The method of claim 1 wherein said the receipt of said control frame invokes a virtual carrier-sensing mechanism in a receiver.

5. The method of claim 1 wherein the selection of said control frame from said first frame and said second frame is further based on: (1) the length of time required to transmit said first frame, (2) the length of time required to transmit said second frame, and (3) the collision fraction of said shared-communications channel.

6. The method of claim 1 wherein the data in the payload of said data frame is received from a host computer.

7. A method comprising:
selecting a control frame from a first frame and a second frame to transmit before a data frame wherein the selection of said control frame is based on the length of time required to transmit said data frame; and
transmitting said control frame on a shared-communications channel, wherein said control frame comprises a duration field that has a value based on the length of time required to transmit said data frame.

8. The method of claim 7 wherein said control frame is transmitted in accordance with a first modulation scheme; and further comprising transmitting said data frame on said shared-communications channel in accordance with a second modulation scheme that is different than said first modulation scheme.

9. The method of claim 7 wherein said first frame is a Request_to_Send frame and said second frame is a Clear_to_Send frame.

10. The method of claim 7 wherein said the receipt of said control frame invokes a virtual carrier-sensing mechanism in a receiver.

11. The method of claim 7 wherein the selection of said control frame from said first frame and said second frame is further based on: (1) the length of time required to transmit said first frame, (2) the length of time required to transmit said second frame, and (3) the collision fraction of said shared-communications channel.

12. The method of claim 7 wherein the data in the payload of said data frame is received from a host computer.

13. An apparatus comprising:
a processor for selecting a control frame from a first frame and a second frame to transmit before a data frame wherein the selection of said control frame is based on the length of time required to transmit said data frame; and
a transmitter for:
transmitting said control frame on a shared-communications channel in accordance with a first modulation scheme; and
transmitting said data frame on said shared-communications channel in accordance with a second modulation scheme that is different than said first modulation scheme.

14. The apparatus of claim 13 wherein said first frame is a Request_to_Send frame and said second frame is a Clear_to_Send frame.

15. The apparatus of claim 13 wherein said control frame comprises a duration field that has a value based on the length of time required to transmit said data frame.

16. The apparatus of claim 13 wherein said the receipt of said control frame invokes a virtual carrier-sensing mechanism in a receiver.

17. The apparatus of claim 13 wherein the selection of said control frame from said first frame and said second frame is further based on: (1) the length of time required to transmit said first frame, (2) the length of time required to transmit said second frame, and (3) the collision fraction of said shared-communications channel.

18. The apparatus of claim 13 further comprising a host computer, wherein the data in the payload of said data frame is received from said host computer.

19. An apparatus comprising:
a processor for selecting a control frame from a first frame and a second frame to transmit before a data frame wherein the selection of said control frame is based on the length of time required to transmit said data frame; and
a transmitter for transmitting said control frame on a shared-communications channel, wherein said control frame comprises a duration field that has a value based on the length of time required to transmit said data frame.

20. The apparatus of claim 19 wherein said control frame is transmitted in accordance with a first modulation scheme; and further comprising transmitting said data frame on said shared-communications channel in accordance with a second modulation scheme that is different than said first modulation scheme.

21. The apparatus of claim 19 wherein said first frame is a Request_to_Send frame and said second frame is a Clear_to_Send frame.

22. The apparatus of claim 19 wherein said the receipt of said control frame invokes a virtual carrier-sensing mechanism in a receiver.

23. The apparatus of claim 19 wherein the selection of said control frame from said first frame and said second frame is further based on: (1) the length of time required to transmit said first frame, (2) the length of time required to transmit said second frame, and (3) the collision fraction of said shared-communications channel.

24. The apparatus of claim 19 further comprising a host computer, wherein the data in the payload of said data frame is received from said host computer.
